(19) United States
(12) Patent Application Publication
(10) Pub. No.: US 2002/0135681 A1
(43) Pub. Date: Sep. 26, 2002

(54) Video monitoring method involving image comparison

(76) Inventor: Kuang-Yao Lo, Tainan Hsien (TW)

Correspondence Address: MORGAN, LEWIS & BOCKIUS LLP, 1111 Pennsylvania Avenue, NW, Washington, DC, 20004, US

(21) Appl. No.: 10/084,350

(22) Filed: Feb. 28, 2002

(30) Foreign Application Priority Data
Mar. 22, 2001 (TW) 090106720

(51) Int. Cl. H04N 5/232; H04N 5/238

(52) U.S. Cl. 348/208.7; 348/208.12; 348/211.9; 348/364

(57) ABSTRACT

In a video monitoring method, each of a series of frame outputs generated by a video camera is defined with a number of image regions. Each of the image regions contains a predetermined segment of a predetermined set of horizontal scan lines of the corresponding frame output. A reference brightness value is obtained for each of the image regions of a reference one of the frame outputs. A current brightness value is then obtained for each of the image regions of a current one of the frame outputs. Each of the current brightness values is compared with a respective one of the reference brightness values to detect movement of an object into one of the image regions of the current one of the frame outputs.

### CROSS-REFERENCE TO RELATED APPLICATION

This application claims priority of R.O.C. Pat. Application No. 090106720, filed on Mar. 22, 2001.

### BACKGROUND OF THE INVENTION

1. Field of the Invention

The invention relates to a video monitoring method, more particularly to one that involves image comparison.

2. Description of the Related Art

In a known video monitoring apparatus, consecutive frames outputted by a video camera, such as a charge-coupled device (CCD) camera, are processed by a digital signal processor (DSP), which in turn controls a drive unit so as to move the video camera in order to track a moving object whose image was captured by the video camera. However, due to the complex nature of electrical signals that constitute each frame output of the video camera, the DSP must be designed to handle a very large amount of real-time image processing operations, thereby increasing the cost of the conventional video monitoring apparatus.

### SUMMARY OF THE INVENTION

Therefore, the main object of the present invention is to provide a video monitoring method that reduces the required amount of real-time image processing operations to result in lower costs.

According to the present invention, a video monitoring method comprises:

a) providing a video camera that generates a series of frame outputs, each of the frame outputs being defined with a number of image regions, each of the image regions containing a predetermined segment of a predetermined set of horizontal scan lines of the corresponding frame output;

b) obtaining a reference brightness value for each of the image regions of a reference one of the frame outputs;

c) obtaining a current brightness value for each of the image regions of a current one of the frame outputs; and

d) comparing each of the current brightness values with a respective one of the reference brightness values to detect movement of an object into one of the image regions of the current one of the frame outputs.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating an apparatus for performing the preferred embodiment of a video monitoring method according to the present invention;

FIG. 2 is a schematic view illustrating a frame output of a video camera that is defined with an array of image regions according to the method of the preferred embodiment;

FIG. 3 is a signal diagram illustrating a composite electrical signal that constitutes the frame output of the video camera;

FIG. 4 is a signal diagram to illustrate an electrical signal corresponding to a horizontal scan line of the frame output of the video camera in greater detail; and

FIG. 5 is a flowchart illustrating the method of the preferred embodiment.

### DETAILED DESCRIPTION OF THE PREFERRED EMBODIMENT

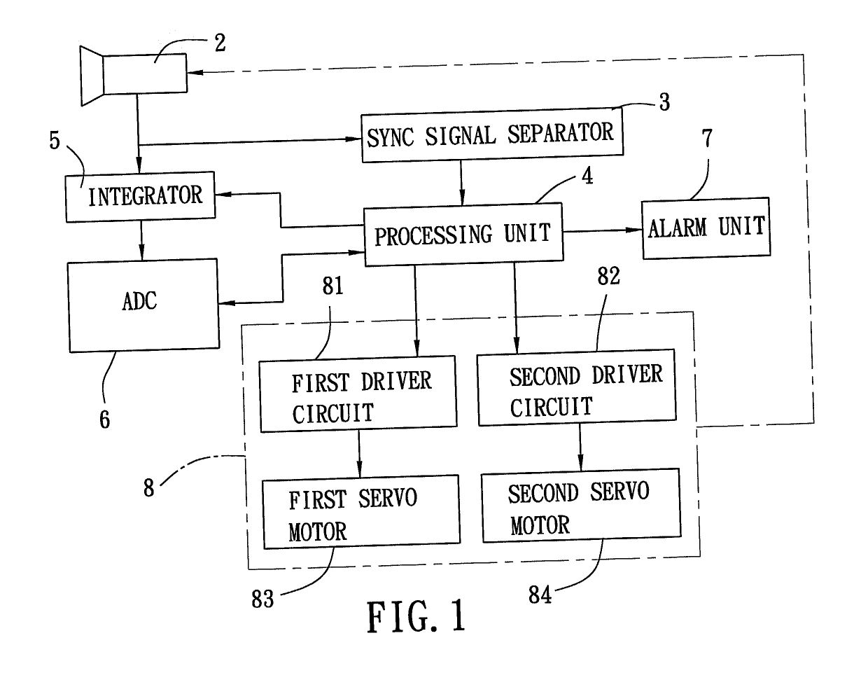

Referring to FIG. 1, the preferred embodiment of a video monitoring method according to the present invention is to be performed by an apparatus that comprises a video camera 2, a sync signal separator 3, a processing unit 4, an integrator 5, an analog-to-digital converter (ADC) 6, an alarm unit 7, and a drive unit 8.

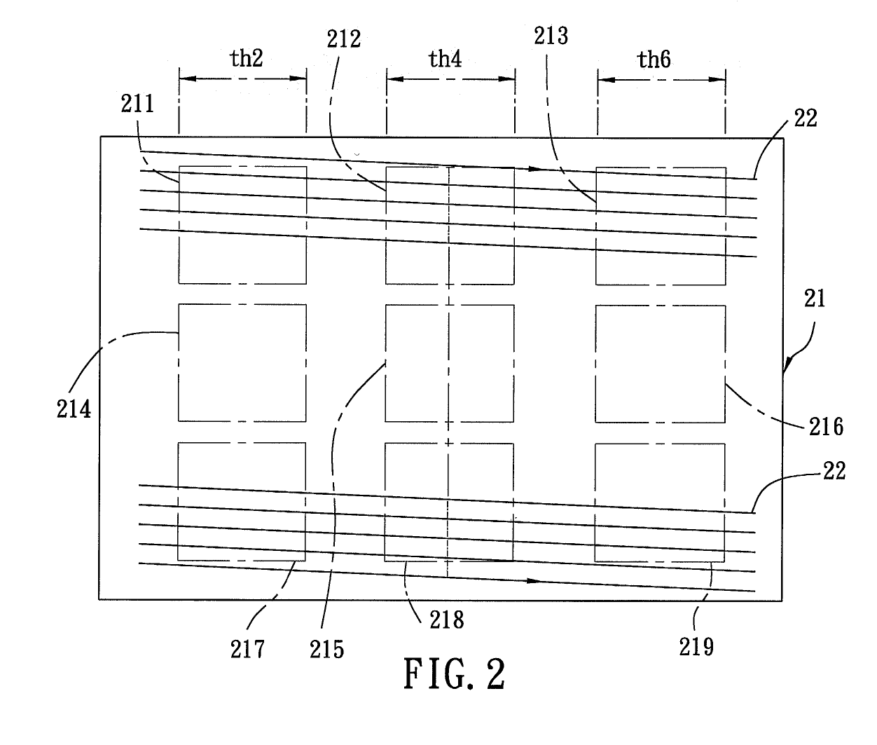

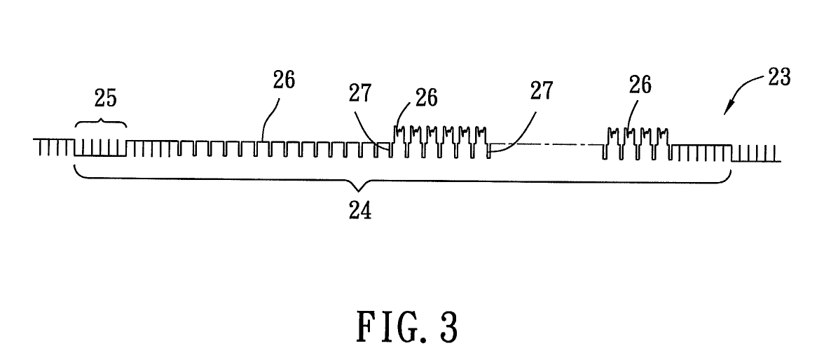

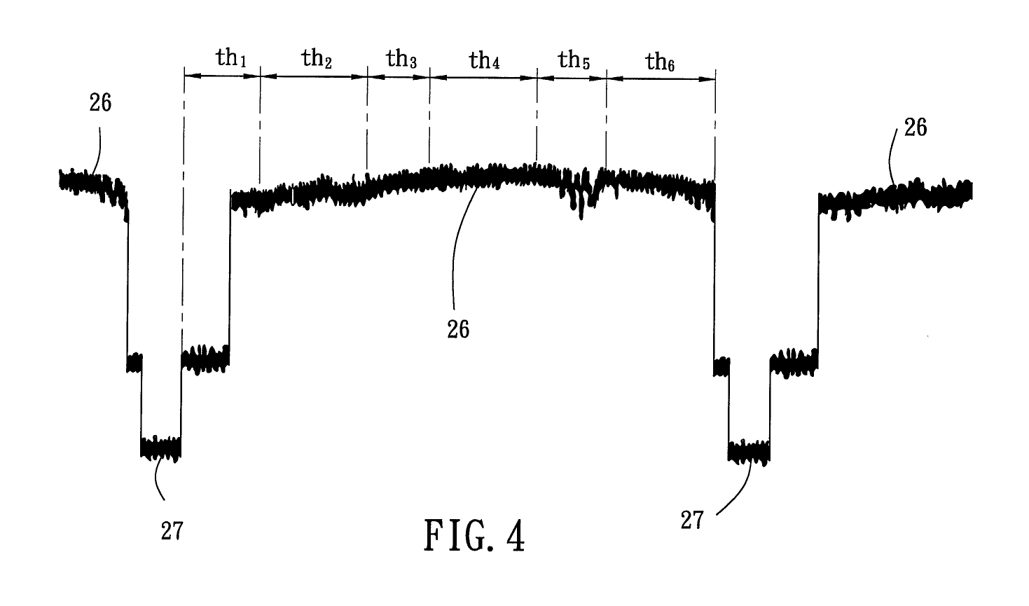

The video camera 2 is a conventional device that generates a series of frame outputs. Each frame output of the video camera 2 is in the form of a known composite electrical signal that includes both picture and synchronizing information. As shown in FIG. 2, a frame output 21 of the video camera 2 includes a plurality of horizontal scan lines 22. With further reference to FIG. 3, the composite electrical signal 23 of the video camera 2 includes a field signal 24 (typically at a field rate of 60 per second). A field synchronizing signal 25 is present at the onset of each field signal 24. Each field signal 24 includes a series of scan line signals 26, each of which contains picture brightness information of a corresponding one of the horizontal scan lines 22. The amplitude of each scan line signal 26 varies to reflect the brightness of the picture elements of the corresponding horizontal scan line 22, as best shown in FIG. 4. As is known in the art, the number of the scan line signals 26 per field signal 24 can vary in accordance with the desired picture resolution. Each scan line signal 26, which has aperiod of about 63.5 μsec in this embodiment, is separated from an adjacent scan line signal 26 by a horizontal synchronizing signal 27.

Referring again to FIG. 2, in the preferred embodiment, each frame output 21 of the video camera 2 is defined with nine image regions 211-219. Each image region 211-219 contains a predetermined segment of a predetermined set of the horizontal scan lines 22. Preferably, the image regions 211-219 are arranged in an array having three rows and three columns and do not overlap.

In the following illustrative example, each field signal 24 includes 243 scan line signals 26, the image regions 211-213 are arranged from left to right and contain the 27^{th} to the 54^{th} horizontal scan lines 22, the image regions 214-216 are arranged from left to right and contain the 108^{th} to the 135^{th} horizontal scan lines 22, and the image regions 217-219 are arranged from left to right and contain the 189^{th} to the 216^{th} horizontal scan lines 22. Thus, the left segment, the middle segment, and 189^{th}-216^{th} horizontal scan lines 22 are contained in a corresponding one of the image regions 211-219.

It should be apparent to one skilled in the art that the number of the horizontal scan lines 22 contained in each of the image regions 211-219 can vary according to actual requirements. When each of the image regions 211-219 contains a relatively large number of the horizontal scan lines 22, detection of small moving objects, such as cats and dogs, can be ensured.

The sync signal separator 3, which is coupled to the video camera 2 and the processing unit 4, receives the composite electrical signal 23 of the video camera 2, and provides the field synchronizing signal 25 and the horizontal synchronizing signals 27 in the composite electrical signal 23 to the processing unit 4.

The processing unit 4 is coupled to and controls operation of the integrator 5 in accordance with the field synchronizing signal 25 and the horizontal synchronizing signals 27 that were received from the sync signal separator 3.

The integrator 5 is coupled to the video camera 2 and is controlled by the processing unit 4 so as to integrate the composite electrical signal 23 of the video camera 2 at appropriate times. More specifically, the integrator 5 generates integrated brightness values for the 27^{th}-54^{th}, 108^{th}-135^{th}, and 189^{th}-216^{th} horizontal scan lines 22 contained in the nine image regions 211-219, and does not generate integrated brightness values for the other horizontal scan lines 22.

Referring again to FIG. 4, in the preferred embodiment, when the integrator 5 receives the scan line signal 26 for one of the horizontal scan lines 22 contained in the nine image regions 211-219 from the video camera 2, the processing unit 4 will divide the scan line signal 26 into six consecutive sub-periods th1-th6, and will control the integrator 5 to generate a corresponding integrated brightness value during the second, fourth and sixth sub-periods th2, th4, th6 only. As shown in FIG. 2, the integrated brightness values for the image regions 211, 214, 217 can be obtained during the second sub-period th2, those for the image regions 212, 215, 217 can be obtained during the fourth sub-period th4, and those for the image regions 213, 216, 219 can be obtained during the sixth sub-period th6.

The ADC 6 is coupled to the processing unit 4 and the integrator 5, receives the integrated brightness values generated by the integrator 5, and is enabled by the processing unit 4 to convert the integrated brightness values into digital brightness values that are received by the processing unit 4. The digital brightness values from the ADC 6 are stored in different registers (not shown) of the processing unit 4 such that cumulative brightness values for the nine image regions 211-219 can be obtained for each frame output 21 of the video camera 2.

After obtaining the brightness values for the image regions 211-219 of a reference frame output 21 of the video camera 2, the brightness values for the image regions 211-219 of a current frame output 21 of the video camera 2 are obtained in the same manner. The processing unit 4 compares the brightness values for the image regions 211-219 of the current frame output 21 with those of the reference frame output 21. Based on the results of the comparison, the processing unit 4 will then control operations of the alarm unit 7 and the drive unit 8 accordingly.

In this embodiment, the alarm unit 7 can be one that generates an audible and/or visible alarm output, avideo recorder, or a wireless signal transmitter. The drive unit 8 is operable so as to adjust the position of the video camera 2, and includes first and second driver circuits 81, 82 coupled to the processing unit 4, and first and second servo motors 83, 84 coupled respectively to the first and seconddriver circuits 81, 82. The first and second servo motors 83, 84 are connected to the video camera 2 via mechanical linkages (not shown). The first servo motor 83 is operable so as to adjust the position of the video camera 2 in a vertical direction, whereas the second servo motor 84 is operable so as to adjust the position of the video camera 2 in a horizontal direction. Since the mechanical linkages that connect the servo motors 83, 84 to the video camera 2 are known in the art, and since the main feature of the invention does not reside in the particular configuration of the mechanical linkages, a detailed description of the same will be dispensed with herein for the sake of brevity.

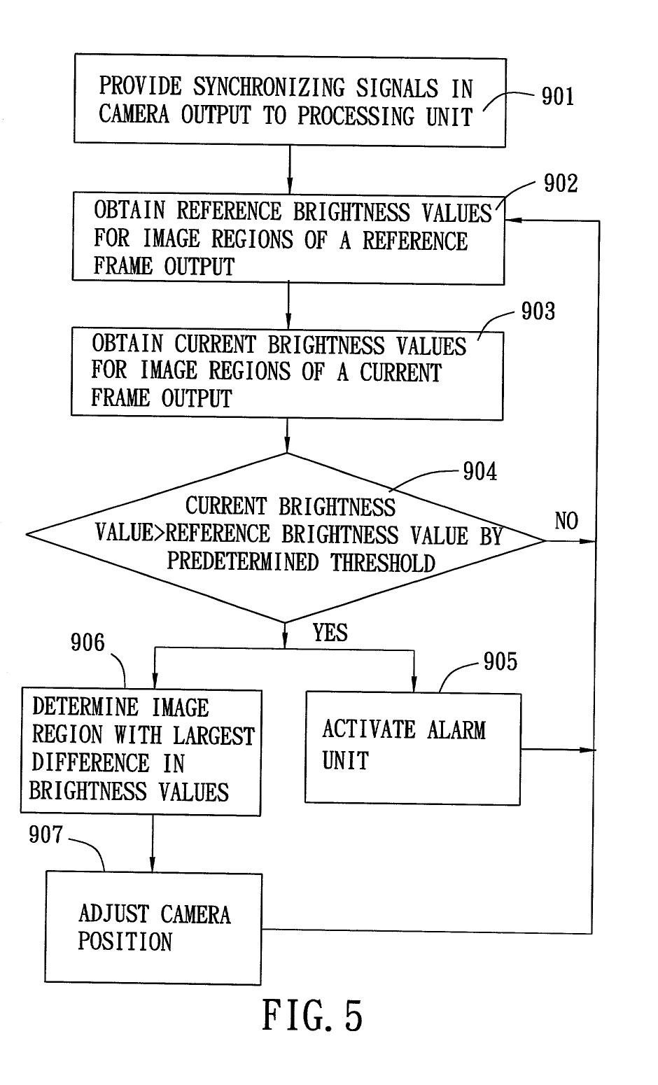

With further reference to FIG. 5, the preferred embodiment of the video monitoring method of this invention will now be described in the following paragraphs:

Initially, in step 901, the composite electrical signal 23 of the video camera 2 is received by the sync signal separator 3, which operates to provide the field synchronizing signal 25 and the horizontal synchronizing signals 27 in the composite electrical signal 23 to the processing unit 4. Then, in step 902, the processing unit 4 controls the integrator 5 to generate the integrated brightness values for the nine image regions 211-219 of a reference frame output 21 of the video camera 2, controls the ADC 6 to convert the integrated brightness values into corresponding digital brightness values, and obtains cumulative brightness values for the nine image regions 211-219, respectively. The cumulative brightness values for the nine image regions 211-219 of the reference frame output 21 serve as reference brightness values.

Thereafter, in step 903, the processing unit 4 obtains current cumulative brightness values for the nine image regions 211-219 of acurrent frame output 21 of thevideo camera 2. In step 904, each of the current cumulative brightness values is compared with a respective one of the reference brightness values. When an object moves into one of the image regions 211-219 of the current frame output 21, a change in the current cumulative brightness value will be detected for said one of the image regions 211-219. Therefore, in step 904, the processing unit 4 determines whether a difference between a current cumulative brightness value and the respective reference brightness value has exceeded a predetermined threshold. If no, the flow goes back to step 902. Otherwise, the processing unit 4 activates the alarm unit 7 in step 905, and the flow goes back to step 902. When the alarm unit 7 is activated, an audible and/or visible alarm output may be generated, recording of the frame output 21 of the video camera 2 may commence, and wireless signal transmission may be initiated to alert security personnel.

In step 906, simultaneous with activation of the alarm unit 7, the processing unit 4 determines which one of the image regions 211-219 of the current frame output 21 of the video camera 2 has the largest difference between current and reference brightness values. Thereafter, in step 907, the processing unit 4 controls the first and second driver circuits 81, 82 such that the first and second servo motors 83, 84 are able to move the video camera 2 so that a succeeding frame output 21 of the video camera 2 will be centered at the determined one of the image regions 211-219 of the current frame output 21 of the video camera 2. In this embodiment, the current frame output 21 is centered at the image region 215. When an object moves into the image region 213, the processing unit 4 will determine the image region 213 to have the largest difference between current and reference brightness values. Thereafter, the processing unit 4 will control operation of the drive unit 8 to move the video camera 2 in vertical and horizontal directions such that the image region 215 of the succeeding frame output 21 will coincide with the image region 213 of the previous frame output 21. The flow then goes back to step 902.

By moving the video camera 2 in the above manner with the use of the drive unit 8, movement of an object whose image was captured by the video camera 2 can be tracked until the object is no longer within the range of coverage of the video camera 2. In the preferred embodiment, the processing unit 4 controls the drive unit 8 to restore the video camera 2 to an initial position upon detection that a predetermined time period (such as 5 minutes) has elapsed and that the differences between the current and reference brightness values for each of the image regions 211-219 no longer exceed the predetermined threshold.

Because ambient lighting changes with time, the current brightness values of the image regions 211-219 will also change with time. However, because the processing unit 4 detects whether the differences between the current and reference brightness values have exceeded a predetermined threshold before activating the alarm unit 7 or the drive unit 8, the effect of natural change in ambient lighting can be neglected. It is also noted that activation and deactivation of artificial lighting can also affect the detected brightness values of the image regions 211-219. Thus, in order to avoid erroneous activation of the alarm unit 7 and the drive unit 8, the processing unit 4 can be designed to verify, for the image region with the largest difference in the current and reference brightness values that exceeded the predetermined threshold, whether such difference is attributed to the captured image of an object with a motion vector before activating the alarm unit 7 and the drive unit 8.

Moreover, when the method of this invention is implemented in a relatively dark environment, an infrared sensor can be installed. More specifically, the infrared sensor can be used to activate a lamp unit upon sensing the presence of body heat due to the approach of a human body, thereby providing illumination that would enable the video camera 2 to generate a series of frame outputs for subsequent processing.

It has thus been shown that, when the image of a moving object is captured by the video camera 2, a change in the brightness value for at least one of the image regions 211-219 will be detected by the processing unit 4. Due to the presence of the drive unit 8, the processing unit 4 can control movement of the video camera 2 for tracking the moving object until the latter is no longer within the range of coverage of the video camera 2.

It is apparent to one skilled in the art that the alarm unit 7 and the drive unit 8 need not be simultaneously employed in the video monitoring method of this invention.

In the method of this invention, because there is no need to compare frame outputs of the video camera 2 in their entirety, the amount of real-time image processing operations is reduced, thereby resulting in a corresponding reduction in the cost of implementing the present invention.

In the preferred embodiment, each frame output 21 of the video camera 2 is defined with nine image regions 211-219 that are arranged in a 3×3 array. However, it should be apparent to one skilled in the art that the number and arrangement of the image regions should not be limited thereto. In order to track a moving object in the aforesaid manner, the image regions should be arranged in an array having an odd number of rows and an odd number of columns. Such an array will be centered in one of the image regions that would permit adjustment of the position of the video camera 2 in the aforesaid manner for object-tracking purposes.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A video monitoring method comprising:
a) providing a video camera that generates a series of frame outputs, each of the frame outputs being defined with a number of image regions, each of the image regions containing a predetermined segment of a predetermined set of horizontal scan lines of the corresponding frame output;
b) obtaining a reference brightness value for each of the image regions of a reference one of the frame outputs;
c) obtaining a current brightness value for each of the image regions of a current one of the frame outputs; and
d) comparing each of the current brightness values with a respective one of the reference brightness values to detect movement of an object into one of the image regions of the current one of the frame outputs.

2. The video monitoring method as claimed in claim 1, wherein in step d), movement of the object into one of the image regions of the current one of the frame outputs is confirmed when the difference between the current brightness value of said one of the image regions of the current one of the frame outputs and the respective reference brightness value exceeds a predetermined threshold.

3. The video monitoring method as claimed in claim 1, further comprising the step of:
e) activating an alarm unit upon detection that an object has moved into one of the image regions of the current one of the frame outputs.

4. The video monitoring method as claimed in claim 1, further comprising the step of:
f) moving the video camera such that a succeeding one of the frame outputs is centered at one of the image regions of the current one of the frame outputs, the current brightness value of said one of the image regions having a largest difference with the respective reference brightness value.

5. The video monitoring method as claimed in claim 4, wherein the image regions of each of the frame outputs are arranged in an array.

6. The video monitoring method as claimed in claim 5, wherein the array has an odd number of rows and an odd number of columns.

7. The video monitoring method as claimed in claim 6, wherein the rows and the columns of the array are equal in number.

8. The video monitoring method as claimed in claim 6, wherein the image regions of each of the frame outputs do not overlap.
